(19) United States
(12) Patent Application Publication
(10) Pub. No.: US 2023/0018951 A1
(43) Pub. Date: Jan. 19, 2023

(54) SOUND DIFFRACTION REDUCTION SPEAKER INCORPORATING META MATERIAL

(71) Applicant: MoFi Electronics LLC, Chicago, IL (US)

(72) Inventor: Andrew Jones, West Hollywood, CA (US)

(73) Assignee: MoFi Electronics LLC, Chicago, IL (US)

(21) Appl. No.: 17/862,126

(22) Filed: Jul. 11, 2022

Related U.S. Application Data
(60) Provisional application No. 63/221,390, filed on Jul. 13, 2021.

(51) Int. Cl. G10K 11/172; H04R 1/02; H04R 7/12

(52) U.S. Cl. CPC G10K 11/172; H04R 1/025; H04R 7/12

(57) ABSTRACT

A speaker device incorporating acoustic meta materials for sound diffraction reduction wherein the meta materials have a plurality of channels to dampen sound waves. Meta materials are applied to the speaker unit, serve as structural components of a speaker baffle, waveguide, and/or cone. The meta materials have openings in them to permit sound waves to enter and positioned at the edges of the speaker cabinet to prevent sound waves from re-radiating and interfering with the sound waves intended for the listener.

### CROSS RELATED APPLICATIONS

This application claims priority to U.S. Provisional Patent Application No. 63/221,390 entitled “Sound Diffraction Reduction Speaker Incorporating Meta Material” filed Jul. 13, 2021, which is incorporated by reference herein in its entirety.

### FIELD OF THE INVENTION

The present invention relates generally to one or more embodiments for a speaker unit, more particularly including meta materials for sound diffraction reduction.

### BACKGROUND OF THE INVENTION

A typical loudspeaker comprises two drive units, a tweeter and a woofer, mounted on the front surface of a rectangular cabinet. Even if the two drive units have perfect responses, when they are mounted into the cabinet in the usual tweeter-over-woofer orientation their responses will be detrimentally modified due to the phenomenon of diffraction. At low frequencies where the wavelength of sound is very large, the cabinet will not impede the radiation of sound from the driver and it will radiate equally in all directions. As the frequency of the sound increases, and correspondingly the wavelength decreases, the sound will begin to focus and radiate in only the forward direction with none going to the rear. The exact transition from one state to the other depends upon the size of the drivers and the size and shape of the front surface of the loudspeaker enclosure.

In the frequency range where the wavelength is comparable to the baffle dimensions, the sound as it meets the edge of the cabinet re-radiates, some going away from the listener and some going forwards towards the listener. It is this forward sound that interferes with the direct sound from the driver to cause the severe response anomalies. Harry F. Olson, Ph.D. discussed this problem in the 1950s and published data in his book “Elements of Acoustical Engineering” in 1957. Olson investigated the effect of not just baffle size but also baffle shape.

The basic problematic behavior at low frequencies is that there exists a step down in response of −6 dB compared to high frequencies, along with a non-smooth frequency response behavior in the transition region from low to high frequencies. The optimum shape on which to mount the drivers is a sphere, but this becomes impractical for multiple drivers and is expensive to manufacture. Modelling programs can predict the impact of baffle size and driver placement on the baffles to help reduce these problematic effects, especially for rectangular cabinets. However, even optimal use of these programs yields only negligible improvement. The magnitude of the low-to-high frequency response problem is a function of the size of the driver relative to size of the baffle. If the driver radiating area is comparable to the baffle area, then the response modification is a smoother function of frequency.

Traditional attempts to address this problem are of two varieties. Generally, they are to make the baffle as big as possible or to make the baffle as small as possible. If the baffle is very large, then the edges are so far away from the driver that their contribution to the step-down problem becomes negligible. This is not a very practical solution, except for when the driver can be flush mounted into a wall. Another possible solution is to mount the tweeter alone on top of the cabinet. In this way, the ratio of driver size to baffle size is minimized thus smoothing out the excess ripple in the response. This technique is favored by certain commercially available loudspeakers, such as those currently sold by Bowers & Wilkins. This approach has drawbacks in matching the directivity function between woofer and tweeter.

Another attempted solution to the low-to-high frequency response problem is to place an absorbent pad around the tweeter to try to absorb the energy that is flowing towards the edge of the cabinet. This has limited success because the efficiency of the absorption is not adequate over the whole range necessary, primarily because the absorbent material cannot practically be made thick enough.

Another attempted solution is to mount the tweeter into a deep waveguide. As noted above if the driver size is comparable to the baffle, the diffraction effect produces a much smoother response, which is easier to equalize and compensate for. A byproduct of a waveguide is that it recesses the tweeter below the baffle surface, and its profile guides the expanding wavefront of the tweeter in such a way as to produce a larger diameter wavefront at the point at which it meets the baffle surface.

Another attempted solution is to utilize a baffle shape, preferably modified in three dimensions, to minimize the diffraction. One such technique consists of rounding the edges with a large radius rather than the hard edge of a conventional cabinet. The strength of the reflection is reduced. But to be properly effective, the radius has to be very large, which adds considerable cost and size to the cabinet. Another approach is to cut or mold facets onto the baffle surface to again reduce the magnitude of the diffraction. Note that these techniques are expensive, and they do not fully remove the diffracted wavefront.

What these techniques fail to fully address is that sound diffracts at the edge of the cabinet and returns to the listener to interfere with the direct sound. The ideal solution would be to fully absorb the sound that propagates to the edge of the baffle before it can diffract and re-radiate. The difficulty with achieving this ideal solution is that ordinarily a sound absorber has to be at least ¼ wavelength thick in order to be able to absorb sound. A one-inch-thick absorber only starts to be effective above 3,000 Hz, and a ½ inch thick absorber only begins to be effective above 6,000 Hz. This is not good enough because the design needs to be able to absorb sound from frequencies in both the low and high ranges since human hearing is in the range of 20 hz to 20,000 hz. This requires an absorber that is closer to 100% effective absorption, or dampening, at much lower frequencies and in a much more compact size. A new class of absorbers, called meta materials, have permitted the development of the inventions described below, which offer a greatly improved solution to sound dampening over the prior art methods.

### SUMMARY OF THE INVENTION

Meta materials have many applications and the term has evolved to have different meanings depending upon the application. References to meta materials with respect to the present invention are intended to refer to acoustic meta materials. Acoustic meta materials are essentially comprised of a collection of maze-like channels. They preferably are open at one end and closed at the other. The channels are of varying lengths. Each individual channel is of a length to be at least a ¼ wave resonant absorber thereby efficiently absorbing over a very narrow band. By stacking a plurality of these different length channels in an array, the channels can be made to stagger resonant frequencies. In this way the meta material channels act together as a wideband absorber. Their absorption efficiency can exceed 95%. The entrances into the channels can be arranged at the anterior edge of the array or across its surface. The anterior edge lies on the side out of which sound is projected by the drivers.

The present invention relates to the dampening or elimination of diffracted sound waves emitted from drivers. It is understood that drivers can take the form of tweeters, woofers, mid range drivers, and base drivers. When referencing any of the specific forms of drivers in the description of the invention, it is intended as an example. It is understood that the invention also applies to any of the other drivers as well.

References to a cone in the present invention is a reference to the vibrational component of the driver contained in a speaker. Such acoustical cones can have a variety of geometries such as conical or elliptical or other geometries in which the walls of the cone expand outward from a central region where electrical energy is transformed into mechanical energy in order to vibrate the cone to generate sound waves. In fact, the cone can be substantially flat in some cases. All such geometries fall within the definition of cone for purposes of the present invention.

In a typical speaker, diffraction occurs at the perimeter edges of the speaker cabinet. An embodiment of the invention places a number of meta material plates about the exterior surface of the speaker cabinet. The plates are mounted to the external surfaces of the lateral sides, top, and bottom. The meta material is comprised of a collection of sound channels. As a practical matter, the channels are organized into meta material plates. The meta material channels have entrances allowing for sound wave entry. The speaker cabinets have a front surface or anterior face. In the present embodiment the channel entrances are located at the anterior edges of the speaker cabinet walls. The channel openings are oriented such that they face outward from the anterior face. In this way, as the sound wave reaches the edge of the cabinet, it is almost fully absorbed by the meta material, which prevents the sound from re-radiating.

In a second embodiment, the cabinet itself is constructed from the meta material plates. In this embodiment the channels and entrances can be either along the meta material plate edges, the outer surfaces of the plates, the inner surfaces of the plates, or any combination of these. This hybrid meta material channel entrance orientation allows for absorbing both diffracted sound from the baffle and sound inside the speaker cabinet.

A third embodiment comprises mounting the meta material onto the front surface of the baffle, with a hole at the center to allow for sound to radiate out from the tweeter. In this embodiment the meta material channel openings may be in one of three locations. At each location the meta material channel openings face anteriorly. The channel entrances may be located either at the inner ring where the baffle encircles the driver, at the outer perimeter of the meta material plate fixed to the baffle, or the channel entrances may be spread across the surface of the meta material plate fixed to the baffle.

In a fourth embodiment, the meta material is be built into the shape of a waveguide. The meta material channel entrances are located and oriented similarly as they are in the third embodiment. The channel entrances may be located either at the center of the waveguide, at the perimeter, or across the surface of the waveguide, depending upon design performance requirements.

In a fifth embodiment, the meta materials are used as the structural component of a driver cone. Driver cones have an interior volume 45 of said cone in which sounds waves travel. It is common practice to construct cones from honeycomb structured materials. These materials provide good strength, light weight, and good internal sound dampening. Meta material is essentially a construction of two skins sandwiching a spacer. Where the spacer is configured to define the sound absorption channels, it can in principle form the structure of the cone itself.

By replacing the honeycomb pattern with the pattern that defines the absorbing channels, we retain the properties that a honeycomb provides, but now have the ability to provide sound absorption. One such application is in a concentric driver. In this type of driver, the tweeter is mounted at the apex of the driver cone. As the sound from the tweeter radiates across the cone to the edge, when it encounters the roll surround attached to the perimeter of the cone it re-radiates similarly to edge diffraction of a cabinet, and so interferes with the direct sound. This typically causes severe frequency response anomalies.

### BRIEF DESCRIPTION OF THE DRAWINGS

These and other features and advantages of the present invention will become appreciated, as the same becomes better understood with reference to the specification, claims and drawings herein:

FIG. 1 shows a sound diffraction reduction speaker with an external meta material plate array comprising channels and channel entrances.

FIG. 2 shows a sound diffraction reduction speaker, as shown in FIG. 1, where the sound diffraction reduction speaker is structurally composed of meta materials.

FIG. 3 shows a meta material plate fixed to a speaker baffle for use in a sound diffraction reduction speaker, as shown in FIG. 1.

FIG. 3A shows a baffled-fixed meta material plate as shown in FIG. 3 where the meta material channel entrances are located at the baffle plate inner ring.

FIG. 3B shows baffled-fixed meta material plate as shown in FIG. 3 where the meta material channel entrances are located at the baffle plate outer perimeter.

FIG. 3C shows a baffled-fixed meta material plate as shown in FIG. 3 where the meta material channel entrances are located across the outer surface of the meta material plate.

FIG. 4 shows a meta material array configured into a wave guide for use in a sound diffraction reduction speaker, as shown in FIG. 1.

FIG. 4A shows a meta material waveguide as shown in FIG. 4 where the meta material channel entrances are about the waveguide center.

FIG. 4B shows a meta material waveguide as shown in FIG. 4 where the meta material channel entrances are about the waveguide perimeter.

FIG. 4C shows a meta material waveguide as shown in FIG. 4 where the meta material channel entrances are about the surface.

FIG. 5 shows a speaker cone comprised of meta materials for use in a sound diffraction reduction speaker, as shown in FIG. 1.

FIG. 5A shows a meta material speaker cone where the metal material channel entrances are located about the inner radius of the driver cone.

FIG. 5B shows a meta material speaker cone where the metal material channel entrances are located about the outer radius of the driver cone.

FIG. 5C shows a meta material speaker cone where the metal material channel entrances are located about the inner surface of the driver cone.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present there between. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

As used herein, the singular forms “a,” “an,” and “the,” are intended to include the plural forms as well, unless the context clearly indicates otherwise. It will be further understood that the terms “comprises” and/or “comprising,” “includes” and/or “including,” and “have” and/or “having,” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” and “upper” or “top,” and “inner” or “outer,” may be used herein to describe one element's relationship to another elements as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

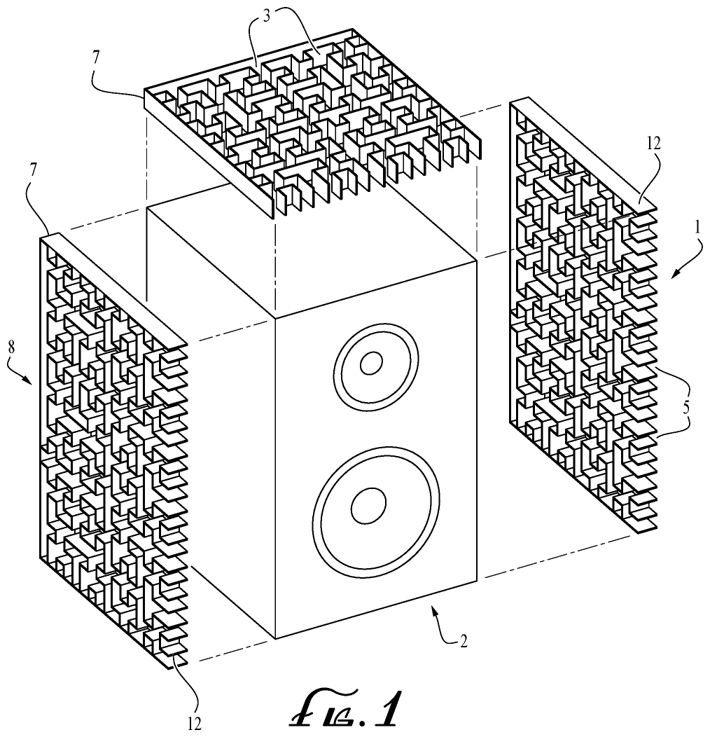

As shown in FIG. 1, meta materials 1 are comprised of a collection of maze-like meta material channels 3. The meta material channels 3 are open at one end and closed at the other. The opening serves to allow for sound wave entry. The meta material channels 3 are of varying lengths. The meta material channels 3 are at least long enough that each meta material channel 3 may serve as a ¼ wave resonant absorber. Sufficient length determination is a function of the building materials used and sound wave volume as mathematically modeled by an expert in the field. Each discrete meta-material channel 3 length provides for efficient sound absorption over a corresponding narrow wave band. By stacking a plurality of these different length channels together as an array and into a plate, the meta material channels 3 can be made to stagger the resonant frequencies absorbed so as to act together as a wideband absorber. In this way their absorption efficiency can exceed 95%. The meta material channels 3 have meta material channel entrances 5 into which sound waves may enter. The meta material channel entrances 5 may be located at an anterior edge 12 of a meta material plate 7, or across its surface, as shown in FIG. 1. The meta material plates 7 serve as a discrete unit of meta material 1. Meta materials 1 and meta material plates 7 are affixed to structural surfaces with adhesive or other suitable attachment means. The adhesive may be of any type suitable for use with speakers.

Diffraction occurs at the perimeter of the cabinet 9 of the speaker 2, which is a structural casing for embodiments of the present invention. As shown in FIG. 1, a first embodiment of the invention places a plurality of meta material plates 7 at outer faces of the cabinet 9. The meta material plates 7 are mounted to the external surfaces of the top, bottom, and sides of the cabinet 9 as shown in FIG. 1. These external surfaces intersect the anterior cabinet face 10. The meta material channel entrances 5 are at the anterior edge 12 of the meta material plates 7. This placement is such that where drivers propel sound waves out through an anterior cabinet face 10, sound waves enter the meta material channels 5 rather than detrimentally diffracting. In this orientation, as the sound wave reaches the edge of the speaker cabinet 9, the waves are almost fully absorbed by the meta material 1, thereby preventing sound from re-radiating.

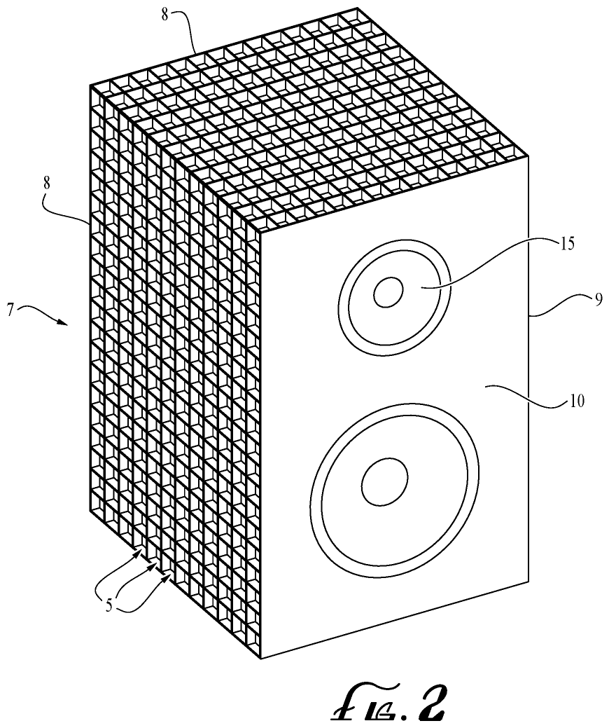

In a second embodiment, the speaker cabinet 7 itself is constructed from the meta materials 1 as shown in FIG. 2. In this embodiment the meta material channel entrances 5 may open along the outer surface 8 of the meta material plate 7. In other embodiments the meta material channel entrances 5 may open along an inner surface 6 which is opposite the outer surface 8, along the anterior edges 12, or in an optimal orientation, any combination of these. The meta material channel entrances 5 absorb both diffracted sound from a baffle 11 or absorb sound inside the speaker cabinet 9.

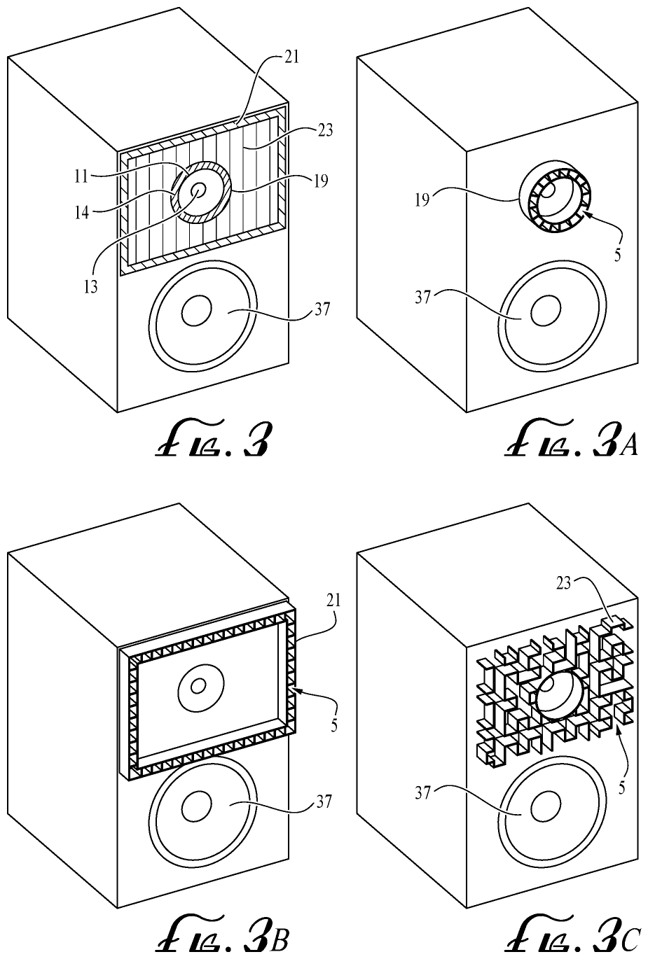

In a third embodiment, a meta material plate 7 is mounted onto a baffle front surface 14 as shown in FIG. 3. The baffle 11 allows sound to radiate from the tweeter 15. The meta material plate 7 mounted on the baffle 11 has three meta material channel entrance 5 locations as shown, but can be any number that is appropriate for the size of the baffle 11. The meta material channel entrance 5 may be either at the baffle plate inner ring 19 as shown in FIG. 3A, the baffle plate outer perimeter 21 as shown in FIG. 3B, spread across the baffle plate surface 23 as shown in FIG. 3C, or any combination of these. In this embodiment the optimal meta material channel entrance 5 orientation is to face anteriorly.

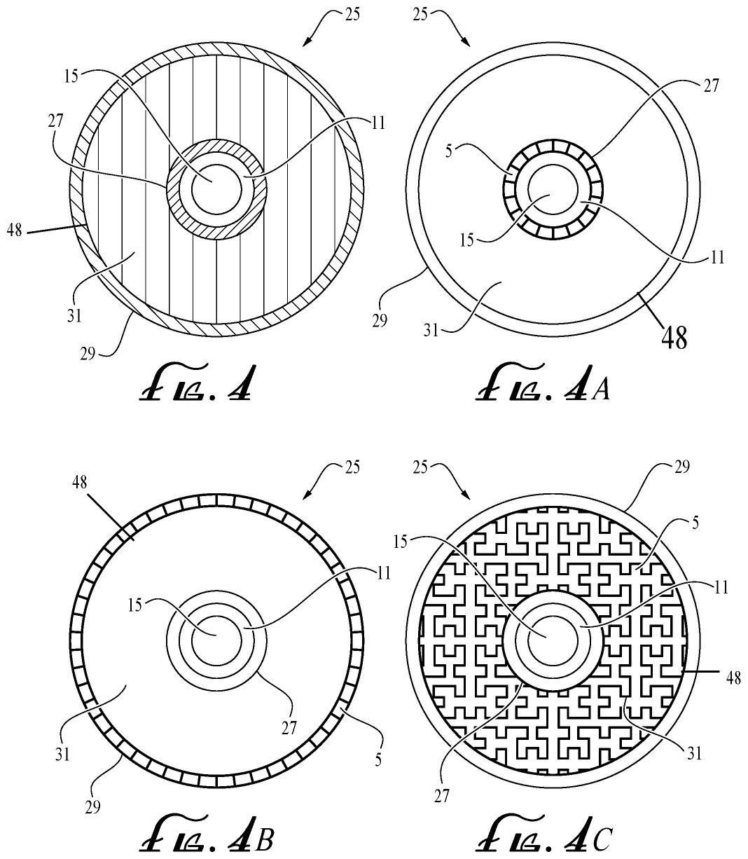

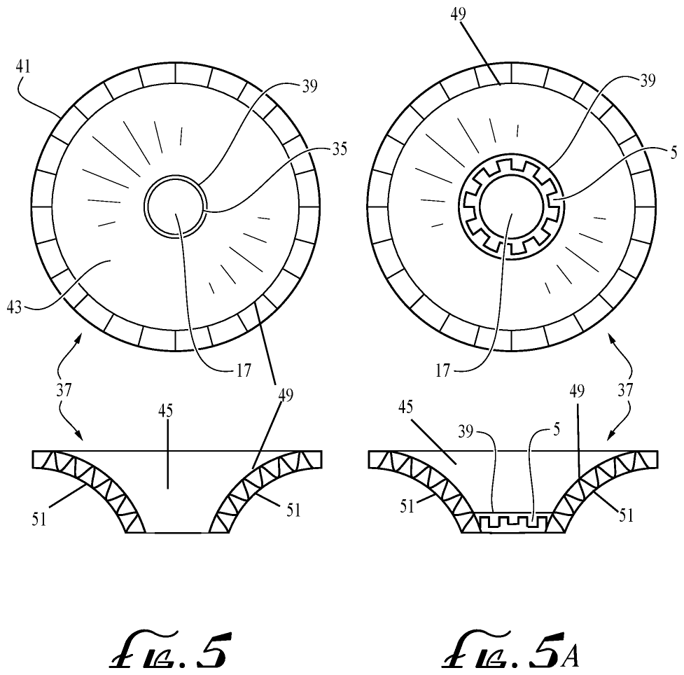

In a fourth embodiment, the meta material 1 can be built into the shape of a waveguide 25 as shown in FIG. 4. The waveguide 25 meta material 5 may be either at the waveguide center 27 as shown in FIG. 4A, at the waveguide perimeter 29 as shown in FIG. 4B, or across the waveguide surface 31 as shown in FIG. 4C, depending upon design performance requirements. In this embodiment, the optimal orientation for the meta material channel entrance 5 is facing anteriorly for meta material placed at the waveguide center 27 and for meta material placed at the waveguide perimeter 29. The optimal orientation for the meta material channel entrance for meta material placed on the waveguide surface 31 is facing the interior volume of the wave guide 48.

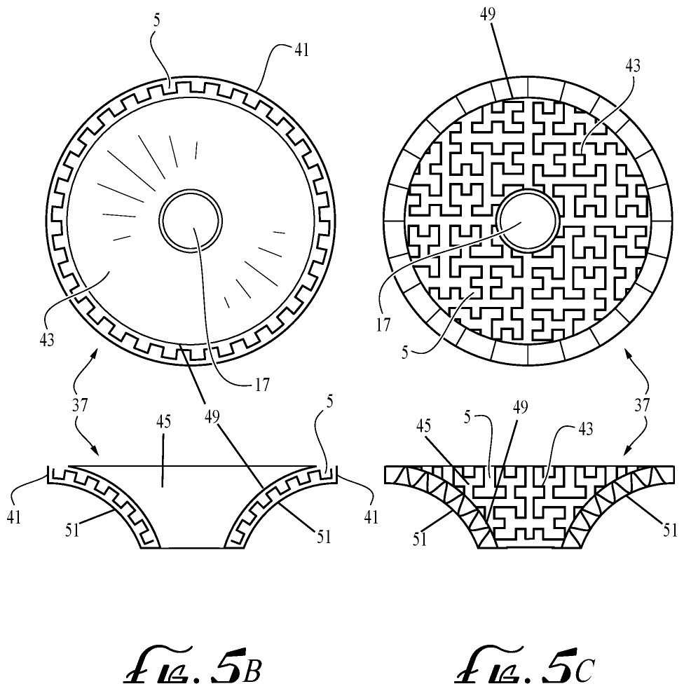

In a fifth embodiment, the meta material 1 is the structural component of a driver cone 37 as shown in FIG. 5. In a preferred embodiment, the driver cone is the woofer cone 37. In this embodiment, the meta material 5 can be mounted within the woofer cone 35 as shown in FIG. 5 at three locations. The meta material 5 may be at a driver cone inner radius 39 as shown in FIG. 5A, a driver cone outer radius 41 as shown in FIG. 5B, or spread across a driver cone inner surface 43 as shown in FIG. 5C, or any combination thereof. The outer surface 51 of the cone faces the interior of the cabinet 9. In FIGS. 5B and 5C, only the cone 35 is shown. One skilled in the art would understand that the other components of the driver to convert electrical energy into acoustical energy are secured to the apex or narrowest point of the cone.

Alternatively, the meta material 5 is positioned on the woofer cone inner surface 43 and can blanket the entire surface. The meta material channel entrances 5 are oriented anteriorly when positioned at the apex of the woofer cone and when positioned at the outer radius of the cone. The meta material channel entrances 5 are oriented toward the interior volume 45 of the cone 37 when the metal material is positioned on the inner surface 43 of the cone 37.

In another embodiment, speaker cone 37 comprises a tapered conical sleave 49, a lesser internal radius 39 at an end of said tapered conical sleave 49, a greater external radius 41 opposite said lesser internal radius 39; and, meta material 1 positioned about said tapered conical sleave 49, said meta material 1 having a plurality of channel entrances 5. The channel entrances 5 can be oriented about said lesser internal radius 39 and said channel entrances 5 face anteriorly or the channel entrances 5 can be about said greater external radius 41 and said channel entrances 5 face anteriorly. Or the channel entrances 5 can be throughout said tapered conical sleave 49 facing the interior volume 45 and said channel entrances 5 face toward the longitudinal axes of said tapered conical sleave 49.

What is claimed is:

1. A speaker having a cabinet with at least one driver having a cone secured within said cabinet, the improvement comprising:
meta material having channels, said channels having entrances;
said meta material fixed in a position in proximity to said cone of said at least one driver;
said position being selected from the group of consisting of:
an inner radius of said cone, an outer radius of said cone, an inner surface of said cone, or combination thereof;
said entrances of said channels capable of receiving diffracted sound; and,
whereby said diffracted sound from said speaker is dampened.

2. The speaker of claim 1, wherein said meta material is positioned at an inner radius of said cone and wherein said entrances of said channels are oriented anteriorly.

3. The speaker of claim 1, wherein said meta material is positioned at an outer radius of said cone and wherein said entrances of said channels are oriented anteriorly.

4. The speaker of claim 1, wherein said meta material is positioned at an inner surface of said cone and wherein said entrances of said channels are oriented toward an interior volume of said cone.

5. The speaker of claim 1, wherein said cone is substantially flat and wherein said meta material is positioned on an inner surface of said cone such that said entrances of said channels are oriented anteriorly outward from said cabinet.

6. A speaker having a cabinet with at least one driver having a cone with a waveguide positioned in front of said driver in which said driver and waveguide are secured to said cabinet, the improvement comprising:
meta material having channels, said channels having entrances;
said meta material fixed in a position in proximity to said waveguide;
said position being selected from the group of consisting of:
a waveguide center, a waveguide perimeter, a waveguide surface, or combination thereof;
said entrances of said channels capable of receiving diffracted sound; and,
a. whereby said diffracted sound from said speaker is dampened.

7. The speaker of claim 5, wherein said meta material is positioned at an inner radius of said waveguide center and wherein said entrances of said channels are oriented anteriorly.

8. The speaker of claim 5, wherein said meta material is positioned at an outer radius of said waveguide perimeter and wherein said entrances of said channels are oriented anteriorly.

9. The speaker of claim 5, wherein said meta material is positioned at an inner surface of said waveguide surface and wherein said entrances of said channels are oriented toward an interior volume of said waveguide.

10. A speaker cone, comprising:
a tapered conical sleave;
a lesser internal radius at an end of said tapered conical sleave;
a greater external radius opposite said lesser internal radius; and,
meta material positioned about said tapered conical sleave, said meta material having a plurality of channel entrances.

11. The speaker cone of claim 9, wherein said channel entrances are oriented about said lesser internal radius and said channel entrances face anteriorly.

12. The speaker cone of claim 9, wherein said channel entrances are about said greater external radius and said channel entrances face anteriorly.

13. The speaker cone of claim 9, wherein said channel entrances are throughout said tapered conical sleave on an inner cone face and said channel entrances face toward the longitudinal axes of said tapered conical sleave.
